(19) United States
(12) Patent Application Publication
(10) Pub. No.: US 2008/0120682 A1
(43) Pub. Date: May 22, 2008

(54) TV-centric system

(76) Inventor: Robert Hardacker, Escondido, CA (US)

Correspondence Address: ROGITZ & ASSOCIATES, 750 B STREET, SUITE 3120, SAN DIEGO, CA, 92101, US

(21) Appl. No.: 11/601,331

(22) Filed: Nov. 17, 2006

(51) Int. Cl. H04N 7/16

(52) U.S. Cl. 725/141

(57) ABSTRACT

A TV has a TV processor and a display presenting a map showing the topology of the home network of which the TV is a part. A user can manipulate the user input device to navigate around the map and cause content to be transmitted from a source component shown in the map to a sink component shown on the map. Using the map, the HDD of a PC can be used in addition to that in a PVR to source content to the TV.

### FIELD OF THE INVENTION

The present invention relates generally to TV-centric home entertainments systems.

### BACKGROUND OF THE INVENTION

As home networks proliferate and improve, they grow more complex with the addition of new devices. For example, a home network may be centered on a TV that can receive information not only from a cable modem and satellite dish but also from digital video recorders (DVRs), digital video disk (DVD) players, and even an in-home computer and the Internet. As understood herein, even technical users can be daunted by visualizing and understanding network participation and connectivity, let alone undertake initial connections of new devices to the networks typically accompanied by authentication and handshaking protocols, updating devices with new software, etc.

As further understood herein, it might happen that a TV might not be associated with a TV-centric hard disk drive such as a DVR, or the DVR might become full. As also recognized herein, in the case of an Internet-enabled TV it might happen that the TV does not possess correct digital rights management (DRM) information for web content, or a web link might be too slow to support real time viewing on the TV, or yet again the user may simply not want to watch a web-sourced program at the time it is available for recording. With these recognitions in mind, the invention herein is provided.

### SUMMARY OF THE INVENTION

A system includes a TV including a processor and a display. The system also includes a computer such as a home PC that communicates with the TV over a network, and the computer includes a data store such as a hard disk drive (HDD). A map can be presented on the display showing the computer and the TV, and a user can manipulate a user input device to navigate around the map and cause content to be transmitted between the data store of the computer and the TV.

In some implementations a digital video recorder (DVR) can also be in the network. The DVR has a DVR HDD and communicates with the TV, and like the computer and TV is presented on the map. If desired, the PC can transcode multimedia streams from a codec that is incompatible with the TV to another codec that is compatible with the TV.

In another aspect, a method includes connecting a TV to a home network that includes a home computer having a hard disk drive (HDD). The computer is not a digital video recorder (DVR). The method includes causing the computer to transcode multimedia streams from a codec that is incompatible with the TV to another codec that is compatible with the TV, and playing back content stored on the HDD on the TV.

In yet another aspect, a home network that is contained entirely within a dwelling includes a TV, a computer with HDD communicating with the TV, and a digital video recorder (DVR) communicating with the TV and having a DVR HDD. A user input device is manipulable to cause content on the DVR HDD to be presented on the TV. Also, the user input device is manipulable to cause content on the computer HDD to be presented on the TV.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting TV-centric system in accordance with the invention;

FIGS. 2-4 are screen shots showing non-limiting network maps that can be displayed on the TV; and

FIGS. 5-8 are flow charts of non-limiting logic that can be undertaken by the TV processor.

### DETAILED DESCRIPTION OF THE PREFERRED EMBODIMENT

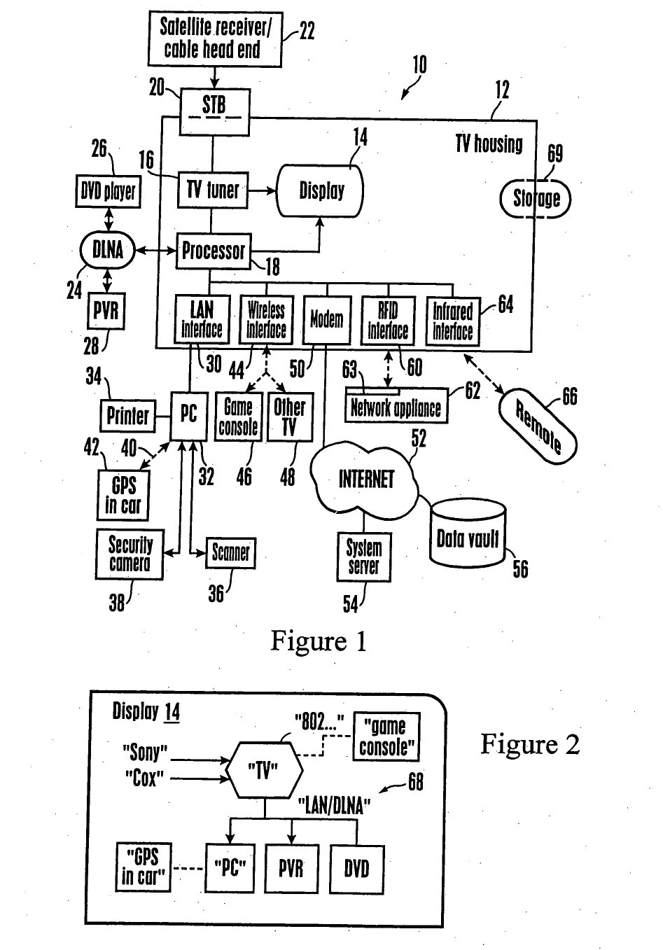

Referring initially to FIG. 1, a system is shown, generally designated 10, which includes a TV housing 12 holding TV components including a TV display 14, a TV tuner 16, and a TV processor 18. The TV tuner 16 may receive input from a set-top box (STB) 20 that, as indicated in FIG. 1, can be part of the housing 12 or alternatively can be in a housing separate from the housing 12. In any case, the STB 20 receives TV signals from one or more sources 22 such as but not limited to satellite receivers, cable system head ends, broadcast receiver antennae, etc. Depending on the nature of the signal, it may be sent directly to the display 14 from the tuner 16 or sent first through the processor 18 for subsequent display. It is to be understood that the STB 20 can communicate with the TV not only through the tuner 16 but also via i-link, HDMI, RF including WiFi, WiMedia, and 60 GHz, Ethernet connection, and other communication forms.

The non-limiting embodiment shown in FIG. 1 illustrates that the present TV can be connected to a plurality of external systems and networks, it being understood that in some implementations not all the components shown in FIG. 1 need be used. In essence FIG. 1 shows a comprehensive TV-centric system for completeness.

In one embodiment, the TV processor 18 may communicate with a digital living network association (DLNA) system 24. Also connected to the DLNA system 24 can be various components including but not limited to a disk player such as a DVD player 26 or Blu-Ray disk player and a personal video recorder (PVR) 28. Information including multimedia streams such as TV programs and movies can be exchanged between the TV processor 18 and the DVD player 26 and PVR 28 in accordance with DLNA principles known in the art.

A local area network (LAN) interface 30 may be provided in the TV housing 12 and connected to the TV processor 18, so that the TV processor 18 can communicate with components on a LAN, implemented in some embodiments as an Ethernet. These components may include a personal computer 32 or other computer, and the computer 32 can communicate with computer network peripheral equipment such as but not limited to a printer 34, a scanner 36, and a security camera 38. All or parts of the computer network may overlap with the various networks with which the TV processor 18 communicates as discussed more fully below.

In addition to Ethernet links, the LAN may include one or more wireless links 40, so that the PC 32 (and, hence, the TV processor 18) may communicate with wireless components such as a vehicle-mounted global position satellite (GPS) receiver 42. Without limitation, the wireless link 40, like other wireless links herein, may be, e.g., an 802.11 link, a Wi-Fi link, a Bluetooth link, an IR link, an ultrasonic link, etc.

In some implementations, a pre-existing computer LAN might exist in the form of twisted pair wiring, coaxial wiring, etc. in a house, and it might be desired to use the pre-existing LAN for the TV components to establish a shared network. In such a case, the physical media is shared between the PC 32 and TV processor 18 with associated components. In one embodiment, the TV components can use a first protocol such as a proprietary protocol while the PC 32 and associated peripherals can use a different, second protocol, so that communication interference is avoided. Alternatively, if a common protocol is used, undesirable devices from the TV standpoint (such as, e.g., the printer 34 and scanner 36) can be removed from the TV network so that, for example, they do not appear on the below-described TV network maps.

When the same protocol is used between the TV processor 18 and the PC 32, the TV processor 18 can be given arbiter rights to manage bandwidth for audio/video data transmissions in the network, and the PC 32 can be given arbiter rights to manage bandwidth for non-audio/video data transmissions. Also, the TV processor 18 may “see” the PC 32 in the TV network but this does not mean that the PC 32 necessarily recognizes the TV components to be part of its network.

Apart from the wireless link 40 of the LAN with which the TV processor 18 may communicate, a wireless communication interface 44 may be in the TV housing 12 and may communicate with the TV processor 18 as shown. The wireless communication interface may wirelessly communicate with various components such as but not limited to a video game console 46, such as a Sony Playstation®, and another TV 48 that might be located in, e.g., another room of the same dwelling. Also, portable devices may connect to the system via wired or wireless paths. These portable devices can include digital still cameras, digital video cameras, audio players, video players, and wireless telephones which may be sources of still pictures, music, vide, and the like.

The processor 18 may also communicate with a computer modem 50 in the TV housing 12 as shown. The modem 50 may be connected to the Internet 52, so that the TV processor 18 can communicate with a web-based system server 54 and a web-based data vault 56. The server 54 may be an IPTV server in which the TV tuner is essentially located in the head end (server 54) or it may be another type of server.

In addition to the wireless communication interface 44 and the modem 50, the TV processor 18 may communicate with a radiofrequency identifier (RFID) interface 60 in the housing 12 or attached thereto using, e.g., a uniform serial bus (USB) cable, to facilitate communication in accordance with RFID principles known in the art between the TV processor 18 and an RFID-enabled network appliance 62 having an RFID device 63 mounted on it or connected to it. Furthermore, the TV processor 18 can, through an infrared interface 64, receive user commands from a remote control device 66 that transmits IR signals, it being understood that the remote control device 66 may alternately use RF, in which case the interface 64 would be an RF interface.

FIG. 1 also shows that the TV can have a data storage 69. The storage 69 may be flash or ROM or RAM in the TV and/or it may be a removable memory device such as a Sony Memory Stick®.

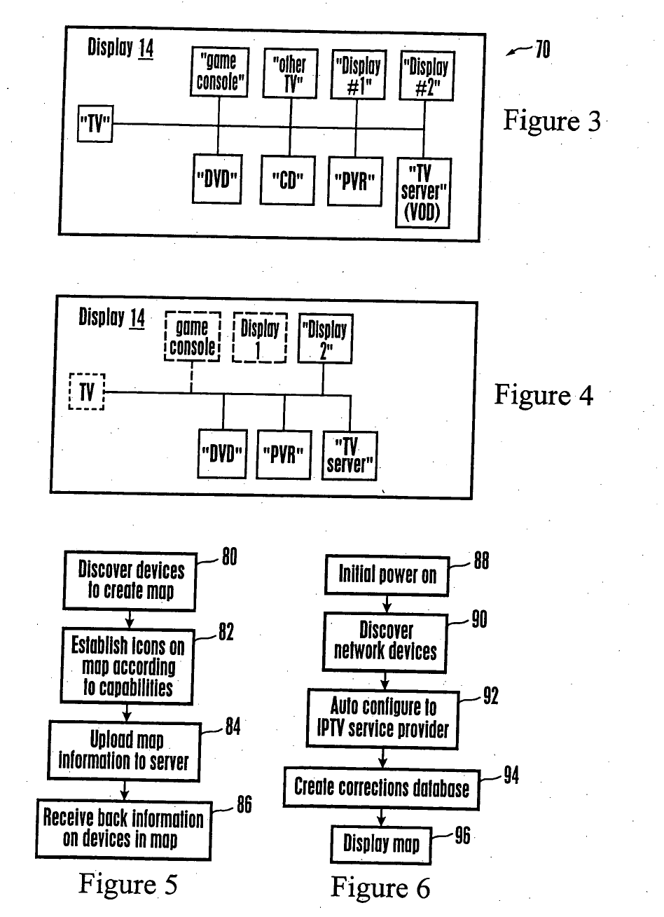

Among the recognitions made herein, it may happen that in some implementations, the TV shown above may not have a hard disk drive (HDD) and/or the PVR 28 may not be available or the correct digital rights management information may be unavailable for recording a program to disk. Accordingly, as shown in FIG. 2 the TV processor 18 may cause to be presented on the TV display 14 a topography map, generally designated 68, that is essentially a user interface that a user can operate on by means of the remote control device 66 to map a HDD in the PC 32 to the TV to thereby allow the user to load content received by the TV onto the PC HDD for later reliable streaming. The PC 32 may also transcode multimedia streams from a codec (such as one intended for the Internet) that might be incompatible with the TV to another, compatible codec. Note that the map 68 shown in FIG. 2 need not show all of the components illustrated in FIG. 1, but can illustrate some or all of the components in the system as desired for simplification. Content stored on the HDD of the PC 32 may later be played back on the TV display 14. Also, content from non-TV sources, e.g., from the DVD player 26, may be sent to the PC 32 HDD for storage.

To operate the UI that is represented by the map 68, a user can manipulate buttons on the remote control device 66 to navigate around the map, clicking on a component with a button designating the component as a “source” and then moving the cursor over the desired “sink” component (in the case shown, the PC) and clicking on a “sink” button to indicate that recording from the source to the sink is to be undertaken. This is but one non-limiting example of how the map 68 can be used to send content from the TV and/or DVD player 26 to the home PC 32.

The map 68 can be created by the TV processor 18 automatically, upon initial connection and perhaps also on every subsequent energization, “discovering” networked devices in accordance with network discovery principles known in the art. Or, a user may be permitted to manually input data to construct the map 68 using the remote control device 66. To this end, near field communications (RFID) can be used, or a keyboard, or a menu selection process, etc.

FIG. 2 also shows that in some implementations the map 68 may show that a networked PC communicates wirelessly with the vehicle-mounted GPS receiver mentioned above. In such an implementation, a user can download a map from the Internet using either the TV processor 18 and modem 50 or using the PC 32, and then manipulate the map 68 in accordance with above principles to cause the map to be transferred wirelessly over the link 40 shown in FIG. 1 to the GPS receiver 42. In this way, a user who has obtained a map from the Internet need not carry the map out to the car and try to read it while driving, but need only load it into the GPS receiver 42, so that the map can be presented by the GPS receiver 42. Upgrades to the software in the GPS receiver 42 may be similarly downloaded from the Internet and wirelessly transferred to the receiver 42.

FIG. 3 shows a screen shot that can be presented on the display 14 to provide a network map 70 that can be used as a user interface for determining an optimum path for a desired function. With more specificity, using the map 70, a user can select a source and sink device for, e.g., playing a multimedia stream and then be presented with information pertaining to a “best” arrangement that can depend on bandwidth considerations and device capabilities.

To illustrate, if a DVD player supports HDMI, S-video, and CVBS and the TV also supports these formats, then the best way to connect the device is using HDMI, with S-video connectivity perhaps being indicated as second best and CVBS indicated as third best. This is true even for “virtual” connections such as Ethernet and RF. This can be indicated by, e.g., displaying a back panel of each device and highlighting the connection terminals corresponding to the “best” communication method, in this case, the HDMI connection terminals.

To further illustrate, assume another hypothetical. A user can move the cursor over each icon shown in FIG. 3 to cause a drop-down menu to appear, showing the capabilities of that device. Assume that it is the user's intentions to find and play “movie A”, and that when the cursor is over the DVD icon, the PVR icon, and the TV internet server icon, a menu appears indicating that “movie A” is stored on the associated component. When the cursor is over the display and TV icons, assume that a menu appears indicating the capabilities of the display, e.g., “HD” or “SD”.

Should the user input “movie A”, the display in FIG. 4 can appear, in which, depending on determinations made by the TV processor 18, some icons representing components that are completely unsuitable for sourcing “movie A” given its format (such as the CD icon) or playing “movie A” given its format (such as the “other TV” icon) are removed from the map 70 entirely while other icons representing components that can source or play, albeit suboptimally, “movie A” (such as the “game console” icon and “display 1” icon) are lowlighted. In lieu of or in addition to icon lowlighting or removal, path lines between icons can be lowlighted or removed.

Thus, only icons (and/or path lines) representing components that can adequately source or play the selection remain on, and a “best” path may be highlighted, e.g., all three source icons (DVD, PVR, and TV server) shown in FIG. 4 remain on, only a single sink icon (“display 2”) remains on, and if bandwidth considerations or quality of service considerations or storage space considerations or other operational considerations indicate that streaming “movie A” from the DVD to the display 2 is the optimum path, that path can be highlighted. In this way, the user knows what the optimal source/sink arrangement is for the desired stream.

The TV processor 18, in conjunction with the above-described network maps, allows users to select optimum sources and sinks in the system 10 to display particular multimedia streams, and to prioritize and schedule more than one event. For instance, a user can undertake the above-described hypothetical selection of “movie A”, store it to memory in the TV for playback at a scheduled future time, and then schedule another event (e.g., record “TV program B”) for an overlapping period. The TV processor 18 in such as case could, in some implementations, recalculate the “movie A” arrangement in light of the desire to record “TV program B” to ensure that bandwidth, QoS, etc. remain optimized.

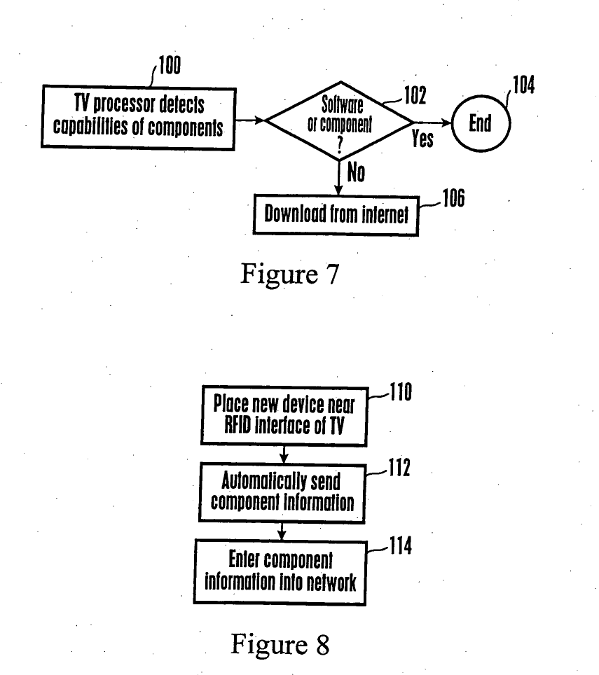

FIG. 5 shows additional map features that can be provided if desired. Commencing at block 80, the TV processor 18 can discover the other components shown in FIG. 1 to generate one or more of the non-limiting network maps described above. At block 82, map icons can be established as appropriate for the underlying device capability, e.g., icons representing non-A/V devices such as the printer 34 may be displayed in a different color than icons representing A/V devices such as the DVD player 26. In the vent that the PC HDD is used as a content source for the TV as described above, its color can be changed from that of a non-A/V device to that of an A/V device automatically in response. Icons representing deenergized devices can be grayed out.

Moving to block 84, the TV processor 18 may upload map information via the modem 50 to the Internet system server 54. In response, the server 54 can return updated device information, diagnostic information, etc. to the TV processor 18 at block 86, so that the map can be updated accordingly.

FIG. 6 shows set up logic that can be used to aid the user in setting up a home network and executed by the TV processor 18 and/or server 54 and/or in accordance with instructions on a removable memory store 69.

At initial TV power-on at block 88, the process moves to block 90 to discover network devices in accordance with disclosure above. Proceeding to block 92, the TV processor 18 is automatically configured for the particular system server 54 that is discovered at block 90. If more than one system server is discovered the user can be prompted to select one. At block 94, a connections database can be created to serve as a starting point for tracking, diagnosing, and recommending future network enhancements. At block 96 a network map can be displayed in accordance with above principles.

In essence, when the TV is first taken out of the box by the user and turned on, the TV processor 18 automatically searches for networks and other connections, e.g., Ethernets, DLNA networks, etc., and then informs the user as to what capabilities exist, showing the map on the display 14. Appropriate configuration of the TV is then automatically executed, relieving the user of the sometimes confusing chore of “setting up” the home network. If no networks are detected the TV processor 18 can prompt the user to “plug in your phone line to the modem 50” or other similar message or, failing that, “call the following help line.”

The TV processor 18 can also ensure component capability maximization by detecting capabilities of components at block 100 in FIG. 7. The capabilities of the components may be communicated to the TV processor 18 from the components themselves, or the TV processor 18 may simply ascertain component identifications and then access a local or web-based database of capabilities corresponding to the detected component IDs.

Moving to decision diamond 102, it is determined whether appropriate software exists on the component to fully exploit the component's capability. If so, the logic ends at state 104, but otherwise necessary software is automatically downloaded from the Internet by the TV processor 18 and transmitted through one or more of the links shown in FIG. 1 to the relevant component. To illustrate, suppose the network appliance 62 shown in FIG. 1 is a wireless telephone, and the TV processor 18 determines that the phone has caller ID service capability but not the actual software to use the service. In this case, the TV processor 18 can access the Internet to download the necessary utility to the phone to enable the caller ID service. This is but one non-limiting example of the TV processor 18 determining that a capability exists on a TV network component but not the necessary software, and obtaining the necessary software from the Internet on behalf of the component.

The RFID interface 60 of the TV can be used to not only communicate with RFID-enabled appliances 62, but also to facilitate easy network set-up. With more specificity and referring now to FIG. 8, recognizing that attaching components to a TV network can be trying and time-consuming owing to entering lengthy strings of media access control (MAC) addresses, cryptographic capabilities and keys, etc., any of the components shown in FIG. 1 may be provided with a RFID device that contains the MAC address of the device, its cryptographic capabilities and keys, etc. At block 110 in FIG. 8 the component is disposed sufficiently close to the RFID interface 60 of the TV to permit the information in the RFID device of the component to be automatically transferred to the TV processor 18 at block 112. At block 114, assuming the information is in order, the component can be entered into the network for, e.g., control, use, and display on one of the network maps discussed above.

While the particular TV-CENTRIC SYSTEM is herein shown and described in detail, it is to be understood that the subject matter which is encompassed by the present invention is limited only by the claims.

What is claimed is:

1. A system, comprising:
a TV including a processor and a display;
a computer communicating with the TV over a network, the computer including a data store; and
a user input device communicating with the processor, wherein
the processor causes a map to be presented on the display showing at least portions of the network including the computer and the TV, wherein a user can manipulate the user input device to navigate around the map and cause content to be transmitted between the data store of the computer and the TV.

2. The system of claim 1, wherein the user input device is a TV remote control device and/or mouse and/or pointing device and the computer is a home PC.

3. The system of claim 2, wherein the data store is a hard disk drive (HDD).

4. The system of claim 3, further comprising a digital video recorder (DVR) in the network and having a DVR HDD, the DVR communicating with the TV and being presented on the map along with the TV and PC.

5. The system of claim 4, wherein the PC transcodes multimedia streams from a codec that is incompatible with the TV to another codec that is compatible with the TV.

6. The system of claim 4, wherein content stored on the HDD of the PC is played back on the TV.

7. The system of claim 6, wherein content from a DVD player or from the DVR is sent to the PC HDD for storage.

8. A method comprising:
connecting a TV to a home network including a home computer having a hard disk drive (HDD), the computer not being a digital video recorder (DVR);
causing the computer to transcode multimedia streams from a codec that is incompatible with the TV to another codec that is compatible with the TV; and
playing back content stored on the HDD on the TV.

9. The method of claim 8, comprising sending content from a DVD player or from a DVR to the HDD of the computer for storage.

10. The method of claim 8, comprising providing a DVR in addition to the computer on the home network.

11. A home network portion contained entirely within a dwelling, comprising:
at least one TV;
at least one computer communicating with the TV, the computer having at least one computer hard disk drive (HDD);
at least one digital video recorder (DVR) communicating with the TV and having a DVR HDD; and
at least one user input device manipulable to cause content on the DVR HDD to be presented on the TV, the user input device also being manipulable to cause content on the computer HDD to be presented on the TV.

12. The network portion of claim 11, wherein the user input device is a TV remote control device and/or mouse and/or pointing device.

13. The network portion of claim 11, wherein the TV includes a processor and a display and the processor causes a map to be presented on the display showing at least the computer, the DVR, and the TV, wherein a user can manipulate the user input device to navigate around the map and cause content to be transmitted between the TV and the HDDs.

14. The network portion of claim 11, wherein the computer transcodes multimedia streams from a codec that is incompatible with the TV to another codec that is compatible with the TV.

15. The network portion of claim 11, wherein content from a DVD player or from the DVR is sent to the PC HDD for storage.
